(19) United States
(12) Patent Application Publication
(10) Pub. No.: US 2026/0364388 A1
(43) Pub. Date: Nov. 19, 2026

(54) PASSIVE FIRE PROTECTION DEVICE COMPRISING A SILICONE FOAM

(71) Applicant: ELKEM SILICONES FRANCE SAS, Saint-Fons (FR)

(72) Inventors: Alexandre LOUIS, Pierre Benite (FR); Thierry MICHEL, Cheyssieu (FR); Emmanuel POUGET, Bron (FR); Bernard MARQUEZ, Neyron (FR)

(21) Appl. No.: 19/147,905

(22) PCT Filed: Jan. 16, 2024
(86) PCT No.: PCT/FR2024/000003

§ 371 Date: Jul. 14, 2025

(30) Foreign Application Priority Data
Jan. 16, 2023 (FR) FR2300394

(51) Int. Cl. A62C 2/06; A62C 3/16; B29C 44/32; C09K 21/14

(52) U.S. Cl. CPC A62C 2/06; A62C 3/16; B29C 44/321; C09K 21/14

(57) ABSTRACT

A passive fire protection device is described herein. The device can include at least one strip including a silicone foam having a density of less than 0.20 g/cm³. The passive fire protection device is particularly useful for the protection of equipment important for the security and safety of an installation including, for example, cables, cable troughs, ventilation and smoke removal ducts, feedthroughs, joints and cabinets.

### TECHNICAL FIELD

The present invention relates to the technical field of silicone foams, and more specifically to the use of silicone foam strips for the passive fire protection of equipment, notably:
cables and cable trays, ventilation and smoke extraction ducts;
feed-throughs (cables, steel, copper, stainless steel piping, etc.), fireproof feed-throughs;
fire seals;
fireproof enclosures protecting specific devices, notably those that are important for the safety and security of a facility, for example pumps, valves, sensors or actuators.

Passive fire protection (“PFP”) denotes all preventive fire protection measures based on the use of fire breaks or fire-resistant structural elements. A “PFP” device is an article which enables a building or part of a building to withstand a fire for a set predetermined time. The fire resistance of a facility may notably be verified and certified via tests performed according to the standard ISO EN 1366 “Fire resistance testing of technical facilities”.

### PRIOR ART

A cable tray is a device allowing the passage of one or more cables (generally electrical cables, computer cables and/or multimedia cables), or pipes to facilitate the distribution of fluids (air, gas, etc.).

It is common practice to use fireproof coatings to protect cable trays. Passive fire protection blankets are generally flexible devices, having firewall properties and mechanical strength up to 1300 °C.

Mention may be made, for example, of the following prior art documents:
patent application EP 0 612 540 A1 describes a flexible protection device having firewall properties, comprising a complex of fibrous and/or textile elements assembled by bonding;
patent application EP 2 072 087 A1 describes a fire protection mat comprising at least two fibrous subassemblies based on mineral fiber wool mats separated by a mineral fiber fabric, at least one layer of refractory adhesive bonding the fibrous subassemblies together, and an envelope comprising a mineral fiber fabric impregnated with a fire-retardant silicone and enclosing all the fibrous subassemblies;
patent application EP 2 694 164 A1 also describes a fire protection coating comprising several superposed fibrous layers and a layer of refractory adhesive placed between two fibrous layers.

In these various documents, the firewall material contains at least one fibrous element. However, in the event of breakage, fibrous products may generate residues which are liable to clog the safety devices of facilities, for example cooling circuits. The presence of fibrous elements is thus inadvisable in high-risk facilities such as nuclear power plants.

Patent application EP 3 799 935 A2 proposed a solution to this specific problem: it describes a fire protection blanket which includes a first layer consisting of a fabric of a heat-resistant material, notably a glass fabric or a meta-aramid fiber fabric, and a second layer consisting of an intumescent material. Furthermore, said document describes a fire protection device using one or more of said staggered blankets. According to said document, the fire protection blankets have the advantage of being light and flexible, and of not risking the projection of fibers which may clog filters in the event of damage to cable tray protections in the case of blowing by a jet of vapor or other. However, assembly of these blankets is difficult: the blankets must be arranged in such a way as to provide zones for expansion of the intumescent material in the event of fire.

In this context, the object of the present invention is to propose a novel passive fire protection device that is flexible, lightweight and easy to handle, having firewall properties and good mechanical strength up to 1300 °C. This novel device is advantageously free of fibrous elements. It allows the protection of equipment that is important for safety and security in high-risk facilities such as nuclear power plants. The novel device may also be removable, cleanable and decontaminable.

More generally, the object of the present invention is to propose a novel device for passive fire protection of equipment, in particular equipment that is important for the safety and security of a facility, for example cables, cable trays, ventilation and smoke extraction ducts, feed-throughs, seals and enclosures.

### SUMMARY OF THE INVENTION

The subject of the present invention is thus a passive fire protection device, said device comprising at least one strip comprising a silicone foam having a density of less than 0.20 g/cm³. Another subject of the invention is a process for preparing a passive fire protection device, said process involving (A) preparing a strip comprising a silicone foam, said preparation comprising the steps consisting in:
preparing a silicone composition that is capable of forming a foam by releasing a gas;
placing said composition in a mold;
closing the mold; and
crosslinking and/or curing said silicone composition to obtain the strip comprising the silicone foam.

A subject of the invention is also the use of said device for passive fire protection of equipment, in particular equipment that is important for the safety and security of a facility, for example cables, cable trays, ventilation and smoke extraction ducts, feed-throughs, seals and enclosures, and particularly for wrapping cable trays, preferably in high-risk facilities such as nuclear power plants.

### BRIEF DESCRIPTION OF THE FIGURES

FIG. 1 represents an embodiment of a mold according to the invention.

FIG. 2 represents an embodiment of a strip before (2A) and after (2B) demolding according to the present invention.

FIG. 3 represents an embodiment of a passive fire protection device according to the invention.

FIG. 4 is a photograph of a strip obtained according to the example according to the invention.

### DETAILED DESCRIPTION OF THE INVENTION

Unless otherwise indicated, all the silicone oil viscosities referred to in the present disclosure correspond to a dynamic viscosity value at 25 °C known as “Newtonian”, i.e. the dynamic viscosity which is measured, in a manner known per se, with a Brookfield viscometer at a sufficiently low shear rate gradient for the measured viscosity to be independent of the rate gradient.

The subject of the present invention is thus a passive fire protection device, said device comprising at least one strip comprising a silicone foam having a density of less than 0.20 g/cm³.

A strip may be defined as a shape whose thickness is significantly less than its length and width. A strip may typically be:
between 50 cm and 5 m long;
between 10 cm and 50 cm wide;
between 1 cm and 5 cm thick.

The term “silicone foam” denotes a composition of organopolysiloxanes in foam form. According to a preferred embodiment, the silicone foam according to the present invention is obtained from a silicone composition which crosslinks by polyaddition and whose foaming reaction generates hydrogen.

Without being bound by any theory, however, the foaming phenomenon may be described as follows: use is made of a polyaddition-crosslinking composition comprising an organopolysiloxane bearing silicon-bonded vinyl groups, an organopolysiloxane containing silicon-bonded hydrogen atoms and a pore-forming agent comprising a hydroxyl group. The hydroxyl group of the pore-forming agent reacts with the organopolysiloxane bearing hydride functions, thus producing hydrogen gas and a silanol.

The silanol then reacts with the organopolysiloxane bearing hydride functions via a hydrogen condensation reaction, generating a second hydrogen gas molecule, whereas another polydiorganosiloxane bearing silicon-bonded vinyl groups simultaneously reacts via an addition reaction with another organopolysiloxane bearing hydride functions, thus helping to build up the silicone foam network.

Although the polyaddition-crosslinking composition described above is the preferred embodiment of the silicone foam according to the present invention, other silicone compositions that are capable of forming a foam are entirely conceivable, insofar as the composition releases a gas enabling the foaming phenomenon. According to one embodiment, the silicone composition contains a pore-forming agent which expands the material under the action of heat by decomposition with release of gas, particularly in the case of azo derivatives, such as azodicarbonamide, which releases nitrogen, carbon dioxide and ammonia. According to another embodiment, the silicone composition contains a pore-forming agent which expands the material under the action of heat by phase change, typically from liquid to gas, notably in the case of low-boiling solvents.

According to a preferred embodiment, the silicone foam is obtained from a silicone composition comprising:
at least one organopolysiloxane A containing, per molecule, at least two silicon-bonded C₂-C₁₂ alkenyl groups,
at least one organopolysiloxane B containing, per molecule, at least two SiH units,
a catalytically effective amount of at least one hydrosilylation catalyst C, and
at least one pore-forming agent D comprising a hydroxyl group.

The organopolysiloxane A, which contains at least two silicon-bonded C₂-C₁₂ alkenyl groups per molecule, may preferably be a linear organopolysiloxane formed:
from at least two siloxyl units of the following formula: YₐR¹_{b}SiO_{(4-a-b)/2}
   in which Y represents a C₂-C₁₂ alkenyl group, preferably a vinyl group; R¹ represents a monovalent hydrocarbon-based group containing from 1 to 12 carbon atoms, preferably chosen from alkyl groups containing from 1 to 8 carbon atoms such as methyl, ethyl, propyl, cycloalkyl groups containing from 3 to 8 carbon atoms and aryl groups containing from 6 to 12 carbon atoms; a=1 or 2, b=0, 1 or 2 and the sum a+b=2 or 3, and
optionally units of the following formula: R¹_{c}SiO_{(4-c/2)}
   in which R¹ has the same meaning as above and c=2 or 3.

It is understood in the above formulas that, if several groups R¹ are present, they may be identical to or different from each other.

In the following part of the description of the organopolysiloxane A, the following nomenclature is used to represent the siloxyl units:
M: siloxyl unit R¹₃SiO_{1/2},
M^{Vi}: siloxyl unit chosen from YR¹₂SiO_{1/2} and Y₂R¹SiO_{1/2},
D: siloxyl unit R¹₂SiO_{2/2},
D^{Vi}: siloxyl unit chosen from Y₂SiO_{2/2} and YR¹SiO_{2/2},
T: siloxyl unit R¹SiO_{3/2},
Q: siloxyl unit SiO_{4/2},
with Y and R¹ as defined previously.

Examples of end units M and M^{Vi} include trimethylsiloxy, dimethylphenylsiloxy, dimethylvinylsiloxy or dimethylhexenylsiloxy groups.

As examples of D and D^{Vi} units, mention may be made of the dimethylsiloxy, methylphenylsiloxy, methylvinylsiloxy, methylbutenylsiloxy, methylhexenylsiloxy, methyldecenylsiloxy or methyldecadienylsiloxy groups.

Examples of T units that may be mentioned include the methylsiloxy group.

The organopolysiloxane A containing at least two silicon-bonded C₂-C₁₂ alkenyl groups per molecule may preferably be a linear organopolysiloxane consisting essentially of siloxyl units D and/or D^{Vi}, and terminal siloxyl units M and/or M^{Vi}.

Examples of linear organopolysiloxanes which may be organopolysiloxane A according to the invention are:
a dimethylvinylsilyl-terminated poly(dimethylsiloxane);
a dimethylvinylsilyl-terminated poly(dimethylsiloxane-co-methylphenylsiloxane);
a dimethylvinylsilyl-terminated poly(dimethylsiloxane-co-methylvinylsiloxane); and
a trimethyl-silyl-terminated poly(dimethylsiloxane-co-methylvinylsiloxane).

Preferably, the organopolysiloxane A contains terminal dimethylvinylsilyl units and even more preferentially the organopolysiloxane A is a dimethylvinylsilyl-terminated poly(dimethylsiloxane).

Preferably, the organopolysiloxane A is an oil with a dynamic viscosity of between 100 mPa·s and 100 000 mPa·s, preferably between 100 mPa·s and 80 000 mPa·s, and more preferentially between 1000 mPa·s and 50 000 mPa·s.

Preferably, the organopolysiloxane A has an alkenyl unit mass content of between 0.001% and 30%, preferably between 0.01% and 10%, preferably between 0.02% and 5%.

The silicone composition preferably comprises from 40% to 80% by weight of organopolysiloxane A, even more preferentially from 50% to 70% by weight of organopolysiloxane A. According to one embodiment, the silicone composition does not comprise any branched organopolysiloxanes or resins comprising C₂-C₁₂ alkenyl units.

The organopolysiloxane B is an organopolysiloxane containing at least two SiH units per molecule. It is thus an organohydrogenpolysiloxane compound. Preferably, compound B comprises at least three SiH units.

The organopolysiloxane B may advantageously be an organopolysiloxane comprising at least two, preferably at least three, siloxyl units of the following formula: H_{d}R²ₑSiO_{(4-d-e)/2} in which R² represents a monovalent radical containing from 1 to 12 carbon atoms, d=1 or 2, e=0, 1 or 2 and d+e=1, 2 or 3;
and optionally other units of the following formula: R²_{f}SiO_{(4-f)/2}
in which R² has the same meaning as above, and f=0, 1, 2, or 3.

It is understood that if several groups R² are present in the above formulae, they may be identical to or different from each other.

Preferentially, R² can represent a monovalent radical chosen from the group consisting of alkyl groups containing from 1 to 8 carbon atoms, optionally substituted with at least one halogen atom such as chlorine or fluorine, cycloalkyl groups containing from 3 to 8 carbon atoms and aryl groups containing from 6 to 12 carbon atoms. R² may advantageously be chosen from the group formed by methyl, ethyl, propyl, 3,3,3-trifluoropropyl, xylyl, tolyl and phenyl.

The symbol d is preferentially equal to 1.

In the following part of the description of the organopolysiloxane B, the following nomenclature has been used to represent the siloxyl units:
M: siloxyl unit R²₃SiO_{1/2},
M′: siloxyl unit R²₂HSiO_{1/2},
D: siloxyl unit R²₂SiO_{2/2},
D′: siloxyl unit R²HSiO_{2/2},
T: siloxyl unit R²SiO_{3/2},
Q: siloxyl unit SiO_{4/2},
with R² as defined previously.

The organopolysiloxane B may have a linear, branched or cyclic structure. The degree of polymerization is preferably greater than or equal to 2. Generally, it is less than 5000. Preferably, the viscosity of the organopolysiloxane B is between 1 mPa·s and 5000 mPa·s, more preferentially between 1 mPa·s and 2000 mPa·s, and even more preferentially between 5 mPa·s and 1000 mPa·s.

In the case of linear polymers, these are essentially formed of siloxyl units D and/or D′, and terminal siloxyl units M and/or M′. In the case of cyclic polymers, these are essentially formed of siloxyl units D and/or D′.

Examples of organohydrogenpolysiloxanes which may be organopolysiloxanes B according to the invention are:
a hydrogenodimethylsilyl-terminated poly(dimethylsiloxane);
a trimethylsilyl-terminated poly(dimethylsiloxane-co-methylhydrogensiloxane);
a hydrogenodimethylsilyl-terminated poly(dimethylsiloxane-co-methylhydrogensiloxane);
a trimethylsilyl-terminated poly(methylhydrogensiloxane); and
a cyclic poly(methylhydrogensiloxane).

When the organopolysiloxane B has a branched structure, it is preferably chosen from the group formed by silicone resins of the following formulae:
M′Q in which silicon-bonded hydrogen atoms are borne by M groups;
MM′Q in which silicon-bonded hydrogen atoms are borne by part of the M units;
MD′Q in which silicon-bonded hydrogen atoms are borne by D groups;
MDD′Q in which silicon-bonded hydrogen atoms are borne by part of the D groups;
MM′TQ in which silicon-bonded hydrogen atoms are borne by part of the M units;
MM′DD′Q in which silicon-bonded hydrogen atoms are borne by part of the M and D units;
and mixtures thereof.

Preferably, the organopolysiloxane B has a mass content of Si—H hydrogenosilyl functions of between 0.2% and 91%, more preferentially between 3% and 80%, and even more preferentially between 15% and 70%.

Advantageously, the mole ratio of Si—H hydrogenosilyl functions of the organopolysiloxanes B to alkene functions of the organopolysiloxanes A is between 5 and 100, preferably between 10 and 90, more preferentially between 15 and 65, and even more preferentially between 20 and 55.

The silicone composition according to the invention preferably comprises from 1% to 20% by weight, and more preferentially from 3% to 15% by weight, of organopolysiloxane B.

The hydrosilylation catalyst C may notably be chosen from platinum and rhodium compounds, but also from silicon compounds such as those described in patent applications WO 2015/004 396 and WO 2015/004 397, germanium compounds such as those described in patent application WO 2016/075 414, or nickel, cobalt or iron complexes such as those described in patent applications WO 2016/071 651, WO 2016/071 652 and WO 2016/071 654. The catalyst C is preferably a compound derived from at least one metal belonging to the platinum group. These catalysts are well known. In particular, the complexes of platinum and of an organic product described in U.S. Pat. Nos. 3,159,601, 3,159,602, 3,220,972 and European patents EP 0 057 459, EP 0 188 978 and EP 0 190 530, and the complexes of platinum and of vinyl organosiloxanes described in U.S. Pat. Nos. 3,419,593, 3,715,334, 3,377,432 and 3,814,730 may be used.

Preferentially, the catalyst C is a compound derived from platinum. In this case, the weight amount of catalyst C, calculated by weight of platinum metal, is generally between 2 ppm and 400 ppm by mass, preferably between 5 ppm and 200 ppm, based on the total weight of the silicone composition.

Preferentially, the catalyst C is a Karstedt platinum.

The pore-forming agent D comprising a hydroxyl group may be chosen from the group formed by water, polyols, monofunctional alcohols, organosilanes containing at least one silanol group, organosiloxanes containing at least one silanol group, and mixtures thereof. According to a preferred embodiment, the pore-forming agent D is water. Water may be added directly to the silicone composition. Alternatively, water may be introduced in the form of an aqueous emulsion, for example a silicone oil-in-water direct emulsion or a water-in-silicone oil reverse emulsion comprising a continuous silicone oil phase, an aqueous phase and a stabilizer. According to one embodiment, water is introduced via a silicone oil-in-water emulsion with a water content of about 60% by weight. When water is introduced into the silicone composition via an emulsion, the dispersion of water in the silicone composition and its stability on storage are improved.

According to another embodiment, the pore-forming agent D is a polyol. Preferably, it is an organic polyol containing from 3 to 12 carbon atoms and comprising at least two hydroxyl groups per molecule. The polyol may be linear or branched, and may optionally comprise one or more aromatic rings. Mention may be made, for example, of saturated polyhydric alcohols containing at least two hydroxyl groups per molecule, such as those described in U.S. Pat. No. 4,871,781. Examples of polyols that may be used as pore-forming agents according to the invention are:
diols, for example 1,2-ethanediol, 2,3-propanediol, 1,3-propanediol, 1,4-butanediol, 1,5-pentanediol and 1,6-hexanediol;
triols, for example 1,2,3-propanetriol and 2,2-bis(hydroxymethyl)butanol;
tetritols, for example erythritol and pentaerythritol;
pentitols, for example arabitol, xylitol and methylpentitol;
hexitols, for example mannitol and sorbitol; and
cycloaliphatic polyols, for example cyclohexanediols, cyclohexanetriols and inositol.

According to another embodiment, the pore-forming agent D is a monofunctional alcohol. Preferably, it is an organic alcohol containing from 1 to 12 carbon atoms and comprising a single hydroxyl group per molecule. The alcohol may be linear or branched, and optionally comprise one or more aromatic rings. Examples of monofunctional alcohols that may be used as pore-forming agents according to the invention are methanol, ethanol, n-propanol, isopropanol, n-butanol, 2-butanol, tert-butanol, n-octanol, benzyl alcohol, and mixtures thereof.

According to yet another embodiment, the pore-forming agent D is an organosilane containing one or more silanol groups. These compounds may, for example, be represented by formula (1) or formula (2) below:

(R³)₃SiOH (1)
(2) (R³)₂Si(OH)₂ in which R³ represents a monovalent radical chosen from the group formed by alkyl groups containing from 1 to 8 carbon atoms, optionally substituted with at least one halogen atom such as chlorine or fluorine, cycloalkyl groups containing from 3 to 10 carbon atoms and aryl groups containing from 6 to 12 carbon atoms. It is understood that if several groups R³ are present in the above formulae, they may be identical to or different from each other.

Examples of organosilanes containing one or more silanol groups which may be used as pore-forming agents according to the invention are (CH₃)₃SiOH, (C₆H₅)SiOH, (CH₃)(C₆H₅)₂SiOH and (C₆H₅)₂Si(OH)₂.

According to yet another embodiment, the pore-forming agent D is an organosiloxane containing one or more silanol groups. Preferably, it may be an organopolysiloxane compound formed:
from at least one siloxyl unit of the following formula: R³_{g}(OH)ₕSiO_{(4-g-h)/2}
in which R³ has the same meaning as above; g=0, 1 or 2, h=1 or 2, and the sum g+h=1, 2 or 3, and
optionally units of the following formula: R³ᵢSiO_{(4-i)/2}
in which R³ has the same meaning as above and i=0, 1, 2 or 3.

The silicone composition may also comprise any other compounds, in particular:
at least one mineral filler, notably silica or quartz, or a mixture thereof;
at least one heat-resistant and/or fire-resistant additive;
at least one diorganopolysiloxane gum;
a diorganopolysiloxane oil blocked at each end of its chain with a triorganosiloxy unit whose organic radicals bonded to silicon atoms are chosen from alkyl radicals containing from 1 to 8 carbon atoms;
a crosslinking inhibitor;
a dye base;
optionally other fillers.

According to a preferred embodiment, the silicone composition comprises a mineral filler, which is preferably a combustion silica or a precipitation silica. Silica-type mineral fillers preferentially have a specific surface area, measured by BET methods, of at least 50 m²/g, notably between 50 m²/g and 400 m²/g, preferably greater than 70 m²/g, a mean primary particle size of less than 0.1 μm (micrometer) and a bulk density of less than 200 g/liter. Very preferentially, the mineral filler is a combustion silica with a specific surface area of between 100 m²/g and 300 m²/g.

Silica-type mineral fillers, which are preferably hydrophilic, may be incorporated into the silicone composition as they are, or optionally treated with a compatibilizer. According to a variant, these silicas may optionally be treated with one or more organosilicon compounds, for example organosilane or organosilazane, which are usually used for this purpose. These compounds include methylpolysiloxanes such as hexamethyldisiloxane, octamethylcyclotetrasiloxane, methylpolysilazanes such as hexamethyldisilazane, hexamethylcyclotrisilazane, tetramethyldivinyldisilazane, chlorosilanes such as dimethyldichlorosilane, trimethylchlorosilane, methylvinyldichlorosilane, dimethylvinylchlorosilane, alkoxysilanes such as dimethyldimethoxysilane, dimethylvinylethoxysilane, trimethylmethoxysilane. These compounds may be used alone or as mixtures (see French patents FR 1 126 884, FR 1 136 885 and FR 1 236 505 and English patent GB 1 024 234). According to a preferred embodiment, the silica is treated during mixing with all or part of the organopolysiloxane A via an in-situ process.

According to an advantageous embodiment, the silica is treated with one or more hexaorganodisilazanes. Even more preferentially, the silica is treated with hexamethyldisilazane alone or as a mixture with divinyltetramethyldisilazane.

The silica may optionally be predispersed in a silicone oil so as to obtain a suspension. In particular, it is preferred to use a suspension of combustion silica treated, notably with hexamethyldisilazane, in a polyorganosiloxane oil, notably a vinyl-treated polyorganosiloxane.

Alternatively or additionally, the silicone composition according to the invention may also contain at least one other mineral filler, namely quartz. Preferably, ground natural quartz with a mean particle size of less than 10 microns is used. Quartz may optionally be treated to improve its compatibility with organopolysiloxanes.

According to a preferred embodiment, the silicone composition comprises a mixture of silica and quartz, with a mass ratio between quartz and silica preferably between 0.5 and 4, more preferably between 1 and 3.6, even more preferably between 1.5 and 3.2, and even more advantageously between 1.5 and 2.8.

Other mineral fillers may also be considered, notably packing fillers, for instance diatomaceous earth, calcium carbonate and/or kaolin.

The silicone composition may optionally comprise at least one heat-resistant and/or fire-resistant additive. These heat-resistant and/or fire-resistant additives are well known to those skilled in the art. They can be advantageously chosen from the group consisting of: salts, oxides and hydroxides of metals such as iron, titanium, aluminum, nickel and copper; salts, hydroxides and oxides of rare-earth metals such as cerium and lanthanum; organophosphorus compounds; platinum derivatives; carbon black; and calcium, aluminum and/or potassium silicates, for instance mica and wollastonite. Mention may also be made of hydrated mineral fillers, calcium, magnesium or aluminum oxides or carbonates, such as magnesium hydroxide Mg(OH)₂, aluminum hydroxide Al(OH)₃, hydromagnesite of empirical formula Mg₅(CO₃)₄(OH)₂·4H₂O, and calcium hydroxide. According to another embodiment, hollow glass microspheres may be added to the silicone composition.

The silicone composition may optionally comprise at least one diorganopolysiloxane gum. Diorganopolysiloxane gums are linear, high-molecular-weight polymers with a viscosity greater than 1000 Pa·s at 25 °C, preferably greater than 2000 Pa·s, and whose diorganopolysiloxane chain consists essentially of units of formula R₂SiO_{2/2} and is blocked at each end with units of formula R₃SiO_{1/2}, the radical R representing an alkyl radical containing from 1 to 8 carbon atoms or an alkenyl radical containing from 2 to 6 carbon atoms. The presence, along the diorganopolysiloxane chain, of small amounts of units other than R₂SiO_{2/2}, for example RSiO_{3/2} and/or SiO_{4/2} units, is however not excluded in a proportion of not more than 2% relative to the number of R₂SiO_{2/2} units. Preferably, the diorganopolysiloxane gums comprise at least two silicon-bonded C₂-C₁₂ alkenyl groups. Advantageously, the diorganopolysiloxane gum has a mass content of vinyl units greater than 0.3%, preferably greater than 0.5%, more preferentially between 0.5% and 6%, even more preferentially between 0.5% and 4%, and even more preferentially between 1% and 3.5%.

When the silicone composition comprises a crosslinking inhibitor (or addition reaction retarder), this may be chosen from the following compounds: an organopolysiloxane, which is advantageously cyclic, and substituted with at least one alkenyl, tetramethylvinyltetrasiloxane being particularly preferred, pyridine, organic phosphines and phosphites, unsaturated amides, alkyl maleates, and acetylenic alcohols, for example 1-ethynyl-1-cyclohexanol, 3-methyl-1-dodecyn-3-ol, 3,7,11-trimethyl-1-dodecyn-3-ol, 1,1-diphenyl-2-propyn-1-ol, 3-ethyl-6-ethyl-1-nonyn-3-ol and 3-methyl-1-pentadecyn-3-ol. According to one embodiment, the silicone composition comprises (by weight relative to the total weight of the silicone composition):
a. from 40% to 80% by weight of at least one organopolysiloxane A containing, per molecule, at least two silicon-bonded C₂-C₁₂ alkenyl groups,
b. from 1% to 20% of at least one organopolysiloxane B containing, per molecule, at least two SiH units and preferably at least three SiH units,
c. from 2 ppm to 400 ppm by mass of a hydrosilylation catalyst C chosen from platinum compounds (amount calculated by weight of platinum metal), and
d. from 0.3% to 2.5% by weight of a pore-forming agent D,
e. at least 3% by weight of a combustion silica with a specific surface area of between 100 m²/g and 300 m²/g,
f. at least 6% by weight of at least one ground quartz mineral filler, and
g. from 0.4% to 5% by weight of at least one heat-resistant and/or fire-resistant additive.

According to another embodiment, the silicone composition comprises (by weight relative to the total weight of the silicone composition):
a. from 40% to 80% by weight of at least one organopolysiloxane A containing, per molecule, at least two silicon-bonded C₂-C₁₂ alkenyl groups,
b. from 1% to 20% by weight of at least one organopolysiloxane B containing, per molecule, at least two SiH units and preferably at least three SiH units,
c. from 2 ppm to 400 ppm by mass of a hydrosilylation catalyst C chosen from platinum compounds (amount calculated by weight of platinum metal),
d. from 0.3% to 2.5% by weight of a pore-forming agent D,
e. from 3% to 14% by weight of at least one mineral filler which is a combustion silica with a specific surface area of between 100 m²/g and 300 m²/g,
f. from 6% to 25% by weight of at least one ground quartz mineral filler,
g. from 0.4% to 5% by weight of at least one fire-resistant additive,
h. from 0 to 3000 ppm by mass of a crosslinking inhibitor, and
i. from 0 to 4% by weight of a diorganopolysiloxane gum comprising at least two silicon-bonded C₂-C₁₂ alkenyl groups.

Such a silicone composition allowing the production of a silicone foam is described, for example, in international patent application WO 2021/014 058.

According to one embodiment, the silicone composition according to the invention can be prepared from a two-component (or multi-component) system characterized in that it is in two (or more) different parts intended to be mixed together to make up said silicone composition. In particular, in the case of the preferred silicone compositions as described above, the silicone composition can be prepared from a two-component system characterized in that one part comprises the catalyst C and does not comprise the organopolysiloxane B, while the other part comprises the organopolysiloxane B and does not comprise the catalyst C. Other multi-component systems may be provided to improve the shelf life and/or optimize the viscosity of each component. For example, the silicone composition according to the invention can be prepared from a three-component system characterized in that it is in three different parts intended to be mixed to make up said silicone composition.

Mixing of the parts of said two-component (or multi-component) system can typically be performed in a mixer (inclined-blade mechanical stirrer, low-pressure dynamic mixer, or any other conventional stirring system) at near-ambient temperature, i.e. between 10 °C and 40 °C. A rise in the temperature of the silicone composition is sometimes observed during this mixing, depending on the type of mixer and the shear applied. If crosslinking or curing of the silicone foam is to be accelerated, the mixing can be performed at a higher temperature, advantageously between 40 °C and 70 °C.

It is important to have good-quality mixing to obtain a homogeneous silicone foam with good mechanical properties.

The silicone composition undergoes a crosslinking and/or curing step to obtain the silicone foam. This step may have a variable duration depending on the silicone composition and the temperature. Generally, a silicone foam with good properties is obtained after a few minutes or a few hours, depending on the temperature and the catalyst and inhibitor concentration in the silicone composition.

The silicone foam according to the invention advantageously has a low density, preferably less than 0.20 g/mL, more preferentially less than 0.17 g/mL. It is visually uniform with a homogeneous distribution of bubble sizes within the foam and does not contain any large bubbles with a diameter greater than or equal to 2 mm.

In addition to its light weight, the silicone foam according to the invention advantageously has good mechanical properties, excellent fire resistance and does not give off toxic fumes when burned.

By virtue of these noteworthy properties, the silicone foam is flexible and easy to handle, and may advantageously be used in a passive fire protection device.

Preferably, the silicone foam according to the invention is not an intumescent material. The term “intumescent material” refers to a material that is capable of swelling under the effect of heat above a certain temperature.

One subject of the invention is a process for manufacturing a passive fire protection device, said process comprising (A) the preparation of a strip comprising a silicone foam, said preparation comprising the steps consisting in:
preparing a silicone composition that is capable of forming a foam by releasing a gas;
placing said composition in a mold;
closing the mold; and
crosslinking and/or curing said silicone composition to obtain the strip comprising the silicone foam.

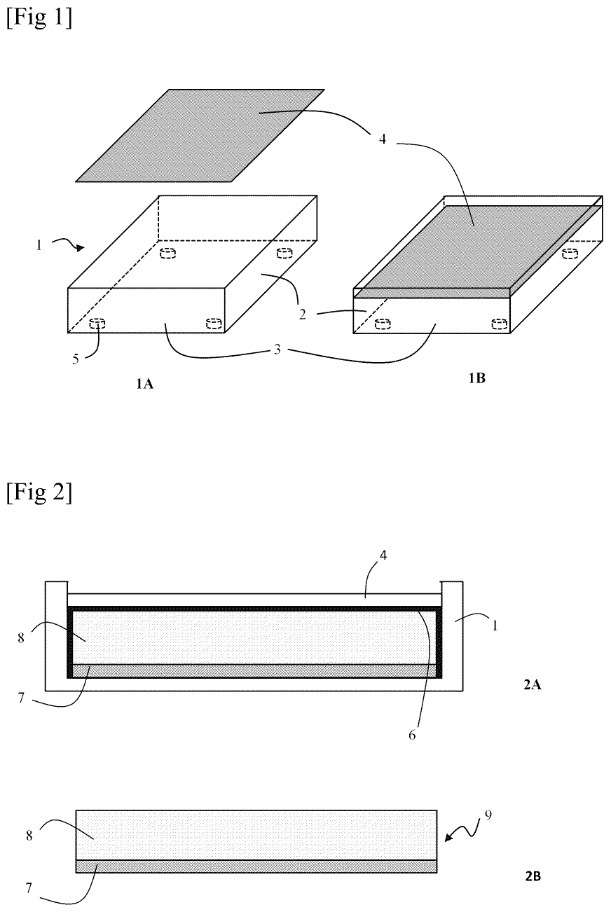

The closed mold defines a hollow volume corresponding to the shape of the article intended to be molded. The mold may have a simple geometrical shape, for example a parallelepiped, as illustrated in FIG. 1.

Preferably, the bottom and top walls of the mold define the largest surfaces of the molded article, while the side walls define the thickness of the molded article.

According to a first embodiment illustrated in FIG. 1, the mold (1) is formed of side walls (2) (four side walls are represented here), a bottom wall (3) and a top wall or cover (4). The bottom wall (3) may optionally be fitted with feet (5) to support the mold. The cover (4) is preferably removable, as shown in FIG. 1. When preparing the strip according to the present invention, the silicone composition may be placed in the mold (1) (configuration 1A), and the cover (4) may then be attached to the side walls, thus defining a closed hollow volume (configuration 1B).

According to another embodiment (not shown), the mold may consist of two mold halves which, when assembled, define a closed hollow volume. When performing the process according to the present invention, the silicone composition may typically be injected into the closed hollow volume defined by the two assembled mold halves.

The walls of the mold may be made of a material suitable for ensuring its mechanical strength, for example metal, typically steel or aluminum, rigid plastic, typically PET, polypropylene or polycarbonate, or of a composite material.

According to a preferred embodiment, the mold comprises a means for evacuating gases generated during the crosslinking and/or curing reaction of the silicone composition. In one embodiment, at least a portion of the walls of the mold according to the invention are formed of two adjacent materials: a rigid gas-permeable outer material, for example a grid or perforated plate, and a gas-permeable, liquid-impermeable inner material. Specifically, as the silicone composition is deposited in a mold in liquid form, it is necessary to provide a leaktight inner material to contain the silicone composition in its liquid form prior to its crosslinking and/or curing reaction. Preferably, said inner material is a flexible material, typically a fibrous material. Said fibrous material may be of natural, artificial and/or synthetic origin. It may be a woven, knitted or nonwoven fibrous material. When it is a woven or knitted fibrous support, i.e. a woven or knitted fabric, the yarns are advantageously based on thermoplastic polymer. Examples of suitable thermoplastic (co)polymers that may be mentioned include: polyolefins, polyesters, polyalkylene oxides, polyoxyalkylenes, polyhaloalkylenes, poly(alkylene phthalate or terephthalate), poly(phenyl or phenylene), poly(phenylene oxide or sulfide), polyvinyl acetates, polyvinyl alcohols, polyvinyl halides, polyvinylidene halides, polyvinyl nitriles, polyamides, polyimides, polycarbonates, polysiloxanes, polymers of acrylic or methacrylic acid, polyacrylates or methacrylates, natural polymers such as cellulose and derivatives thereof, synthetic polymers such as synthetic elastomers, or thermoplastic copolymers comprising at least one monomer identical to any of the monomers included in the above-mentioned polymers, and also mixtures and/or alloys of all these (co)polymers. When the fibrous material is made of a thermoplastic polymer, it is preferably polyester, such as polyethylene terephthalate (PET), polypropylene terephthalate (PPT), polybutylene terephthalate (PBT), copolymers and mixtures thereof, or polyamide, such as polyamide 6, polyamide 6.6, polyamide 4, polyamide 1.1, polyamide 1.2, polyamides 4-6, 6-10, 6-12, 6-36, 12-12, copolymers thereof and mixtures thereof.

Also according to this preferred embodiment, at least the top and bottom walls of the mold are designed to allow the escape of gases generated during the crosslinking and/or curing reaction of the silicone composition. Specifically, the bottom and top walls of the mold preferably define the largest surfaces of the molded strip. The side walls, which preferably define the thickness of the strip, have a smaller surface area.

After depositing the silicone composition, the mold may be closed, for example using a lid, as shown in FIG. 1B. The hollow volume defined by the closed mold should preferably remain fixed and withstand the pressure created by the expanding foam. Fixing means are known to those skilled in the art, for example fasteners between the lid and the side walls, weights spread over the top of the lid, or a hydraulic system to keep the lid closed.

Finally, strip preparation includes a step consisting in allowing said silicone composition to crosslink and/or cure, to obtain a silicone foam. This step may have a variable duration depending on the silicone composition and the temperature of the preceding deposition step. Generally, a silicone foam with good properties is obtained after a few minutes or a few hours, depending on the temperature and the catalyst and inhibitor concentration in the silicone composition.

Advantageously, the entire silicone foam manufacturing process is performed under air or nitrogen flushing to avoid risks associated with hydrogen evolution during the process.

Furthermore, the silicone foam manufacturing process is preferably performed at atmospheric pressure and room temperature, also to avoid the risks associated with hydrogen evolution. Room temperature is generally between 15 °C and 40 °C, typically about 25 °C. In addition to safety considerations, performing the process at atmospheric pressure and/or room temperature is a major advantage in terms of technological simplification and implementation costs.

The process according to the present invention may optionally comprise an additional step consisting in annealing the silicone foam. This optional annealing step may consist of a heat treatment lasting from 1 to several hours, preferably from 1 to 4 hours, at a temperature of between 50 °C and 200 °C, preferably between 100 °C and 150 °C. This may allow the fire-resistance and mechanical properties of the silicone foam to be improved, if required. However, this step is not essential, and a process characterized in that it does not comprise any additional annealing step is preferred.

After crosslinking and/or curing, and optionally annealing, a strip comprising silicone foam is obtained, and can be demolded. Advantageously, the material of the inner face of the mold, i.e. the material in contact with the silicone composition before its crosslinking and/or curing, and then in contact with the silicone foam after its crosslinking and/or curing, is chosen in such a manner that demolding is easy. For this purpose, the material is chosen from those which adhere little or not at all to the silicone foam after its crosslinking and/or curing. Preferably, the material of the inner face of the mold is polyester.

Alternatively, the material may be surface-treated to improve its non-adhesion to the silicone foam, for example with a fluorocarbon coating.

In addition to silicone foam, the passive fire protection device according to the present invention may advantageously comprise a textile support. Textile supports that can be used in passive fire protection devices are known to those skilled in the art. Certain examples are described in patent application EP 3 799 935 A2. The textile support is preferably formed from a heat-resistant material, for example a glass fabric resistant to heat in excess of 500 °C or a meta-aramid fiber fabric. Glass fabric has the advantage of being inexpensive and offering good mechanical strength.

According to a preferred embodiment, the strip comprises a layer of silicone foam and a textile support. In this context, step (A) of preparing the strip also comprises a step consisting in placing a textile support in the mold before depositing the silicone composition that is capable of forming a foam by releasing a gas. Step (A) may thus be described in the following manner:
preparing a silicone composition that is capable of forming a foam by releasing a gas;
placing a textile support in a mold;
applying said composition to said textile support;
closing the mold; and
crosslinking and/or curing said silicone composition to obtain the strip comprising the silicone foam.

After crosslinking and/or curing, the silicone foam obtained adheres to the textile support. The strip comprising the silicone foam layer and the textile support can be demolded.

FIG. 2 represents a strip thus obtained before demolding (configuration 2A) and after demolding (configuration 2B). The strip (9) comprises a textile support (7) and a layer of silicone foam (8) adhering to the textile support (7). According to the illustrated embodiment, certain inner walls of the mold (1) and lid (4) have been coated with a nonstick polyester fibrous material (6). During demolding, the cover (4) is removed and the strip (9) can be easily removed from the mold (1).

Advantageously, it is possible for the strip not to comprise any adhesion primer between the silicone foam layer and the textile support. Specifically, in the preparation process described above, the crosslinking and/or curing reaction of the silicone foam takes place directly on the textile support and adhesion is thus obtained without any additional adhesion primer.

The process for manufacturing a passive fire protection device according to the present invention may also involve (B) assembling one or more of said strips comprising silicone foam.

Assembly may be performed by a person skilled in the art via methods known in the technical field. A device may comprise several thicknesses of strips joined together mechanically and/or chemically (bonding). For example, a strip comprising silicone foam according to the invention may be wound on itself. According to another example, several strips according to the invention may be stacked on top of each other. An intermediate layer may optionally be positioned between each strip. This may optionally contain additives useful for passive fire protection and/or mechanical reinforcement.

According to a first embodiment, the passive fire protection device according to the present invention may comprise, in addition to said strip(s) comprising silicone foam, one or more layers containing additives useful for passive fire protection. Such additives are known to those skilled in the art in this technical field. The term “additives useful for passive fire protection” refers to compounds which prevent or inhibit the spread of fire. Mention may be made notably of metal hydroxides, which decompose under the effect of heat and release water. Among the metal hydroxides most widely used for their passive fire protection properties, mention may be made of aluminum hydroxide (ATH) and magnesium hydroxide. The use of refractory particles is described, for example, in patent application EP 2 072 087 A1. These may notably include metal metasilicates, for example sodium metasilicate hydrate (Na₂SiO₃·nH₂O). The use of such additives advantageously allows the device's fire resistance properties to be improved and can retard the temperature rise of the equipment it is intended to protect.

According to an alternative embodiment, the passive fire protection device according to the present invention does not contain any additives that are capable of releasing basic water at high temperatures. In particular, the passive fire protection device according to the present invention does not contain any metal metasilicates. However, without wishing to be bound by this theory, the inventors believe that the strip of silicone foam might be degraded at high temperature by the possible release of alkali metal hydroxides by the metal metasilicates.

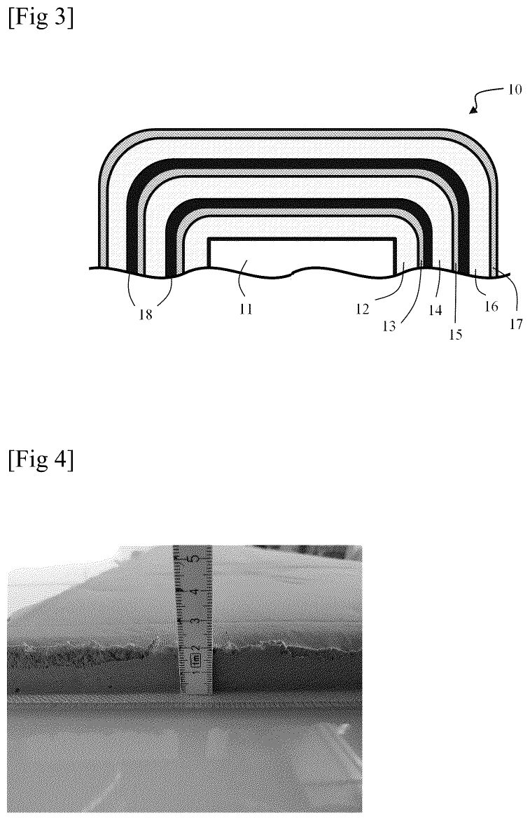

FIG. 3 represents one embodiment of a passive fire protection device (10) according to the invention, comprising three strip thicknesses arranged around a cable tray (11). The first strip thickness comprises a first layer of silicone foam (12) and a first textile support (13). This first strip thickness is assembled with a second strip thickness which comprises a second silicone foam layer (14) and a second textile support (15). This second strip thickness is assembled with a third strip thickness which comprises a third silicone foam layer (16) and a third textile support (17). Between each strip thickness is an intermediate layer (18), which may contain additives useful for passive fire protection and/or mechanical reinforcement. However, according to one embodiment not shown, the passive fire protection device (10) according to the invention does not comprise an intermediate layer (18), the strip thicknesses then being directly adjacent to each other.

The first, second and third strips, comprising a silicone foam layer and a textile support layer, may have a thickness typically between 1 cm and 3 cm. The intermediate layers may have a thickness typically between 0 cm and 2 cm. The whole device after assembly may thus have a thickness, according to this embodiment, of between 3.2 cm and 13 cm.

One subject of the invention is also the use of said device for passive fire protection of equipment, in particular equipment that is important for the safety and security of a facility. Among the equipment targeted, mention may be made, for example, of:
cables and cable trays, ventilation and smoke extraction ducts;
feed-throughs (cables, steel, copper, stainless steel piping, etc.), fireproof feed-throughs;
fire seals;
fireproof enclosures protecting specific devices, notably those that are important for the safety and security of a facility, for example pumps, valves, sensors or actuators.

In particular, the targeted equipment may be chosen from those that are important for the safety and security of a facility, notably a high-risk facility, such as a nuclear power plant. According to a specific embodiment, the subject of the invention is the use of said passive fire protection device for wrapping cable trays, preferably in high-risk facilities, such as nuclear power plants. According to another specific embodiment, the subject of the invention is the use of said passive fire protection device for the manufacture of hopper sleeves, notably cables, tubes or hoses.

In addition to being free of fibrous elements, allowing safety and security to be ensured in high-risk facilities, the passive fire protection device proposed by the present invention has been eco-designed to be light, flexible, easy to handle, removable, cleanable and decontaminable. The device can be disassembled and reassembled on facilities, without having to be replaced entirely with a new one. The product's negative impact on the environment over its entire life cycle may thus be reduced, while at the same time maintaining its working qualities.

Other details or advantages of the invention will be seen more clearly from the examples below, given purely for illustrative purposes.

### EXAMPLES

A silicone composition, capable of forming a foam and crosslinking by polyaddition, was prepared by mixing at room temperature the compounds described in Table 1 below:

TABLE 1

| | | Weight % |
|---|---|---|
| Organopolysiloxane A | Mixture of dimethylvinylsilyl-terminated | 56.2 |
| | poly(dimethylsiloxane), viscosity = 3500 to | |
| | 20 000 mPa · s | |
| Organopolysiloxane B | Trimethylsilyl-terminated poly(methylhydro- | 12 |
| | genosiloxane), viscosity = 30 mPa · s | |
| Catalyst C | Karstedt platinum catalyst | 0.04 |
| Pore-forming agent D | Silicone emulsion containing about 59.5% by | 1.16 |
| | weight of water | |
| Silica | Combustion silica having a specific surface area | 9.4 |
| | of 300 m²/g treated with a mixture of | |
| | hexamethyldisilazane and | |
| | divinyltetramethyldisilazane | |
| Quartz | Ground quartz, half the particles of which have a | 15 |
| | size of less than or equal to 4 microns | |
| Organopolysiloxane | Diorganopolysiloxane gum consisting essentially | 1.5 |
| gum | of dimethylsiloxane and methylvinylsiloxane | |
| | units comprising 2.4% by weight of vinyl units | |
| Heat-resistant and fire- | Mixture of titanium oxide, mica and cerium | 3.7 |
| resistant additive | hydroxide | |
| Crosslinking inhibitor | Solution containing 1% of ethynylcyclohexanol | 1.0 |
| | in a polydimethylsiloxane oil blocked with | |
| | (CH₃)₂(Vi)SiO_{1/2} units, having a viscosity of | |
| | 600 mPa · s at 25 °C | |

In a mold consisting of a perforated steel frame measuring 150×35×2 cm, a polyester fabric was placed on the bottom, followed by a commercial glass fabric about 2 mm thick. A cover, also consisting of a perforated steel plate, was covered with polyester fabric.

The silicone composition was deposited in the mold on the glass fabric, spread evenly over the bottom of the mold using a scraper (liquid layer of about 3 mm), and the cover was then attached to the frame in such a way as to form a closed mold.

After 45 minutes at 23 °C, the foam obtained was demolded. As can be seen from FIG. 4, the strip thus obtained comprises a glass fabric and a layer of silicone foam. The density of the foam is of the order of about 0.15 g/mL. The silicone foam adheres perfectly to the support glass fabric. The strip obtained is homogeneous, light and flexible. It can be readily handled and folded.

A facility protected with the strip obtained as described above is tested in accordance with the European standard EN 1366-3. After passing the fire resistance test, the overall system obtains the EI 120 classification. This is the classification for the fire behavior of construction products (E=Sealing—ability of a component with a partitioning function to withstand fire penetration on the non-fired side; I=Insulation—ability to prevent heat transfer on unilateral exposure to fire as long as no surface or material is ignited on the non-fired side) and for the duration of fire resistance (120=Duration in minutes—time during which all the E and I criteria are met).

1. A passive fire protection device, the device comprising at least one strip comprising a silicone foam having a density of less than about 0.20 g/cm³.

2. The passive fire protection device as claimed in claim 1, wherein the silicone foam is obtained from a silicone composition that crosslinks by polyaddition and whose foaming reaction generates hydrogen.

3. The passive fire protection device as claimed in claim 1, wherein the silicone foam is obtained from a silicone composition comprising:
at least one organopolysiloxane A containing, per molecule, at least two silicon-bonded C₂-C₁₂ alkenyl groups,
at least one organopolysiloxane B containing, per molecule, at least two SiH units,
a catalytically effective amount of at least one hydrosilylation catalyst C, and
at least one pore-forming agent D comprising a hydroxyl group.

4. The passive fire protection device as claimed in claim 3, wherein the silicone composition comprises (by weight relative to the total weight of the silicone composition):
a. from about 40% to about 80% by weight of at least one organopolysiloxane A containing, per molecule, at least two silicon-bonded C₂-C₁₂ alkenyl groups,
b. from about 1% to about 20% of at least one organopolysiloxane B containing, per molecule, at least two SiH units,
c. from about 2 ppm to about 400 ppm by mass of a hydrosilylation catalyst C chosen from platinum compounds (amount calculated by weight of platinum metal),
d. from about 0.3% to about 2.5% by weight of a pore-forming agent D,
e. at least about 3% by weight of a combustion silica with a specific surface area of from about 100 m²/g to about 300 m²/g,
f. at least about 6% by weight of at least one ground quartz mineral filler, and
g. from about 0.4% to about 5% by weight of at least one heat-resistant and/or fire-resistant additive.

5. The passive fire protection device as claimed in claim 1, wherein the passive fire protection device comprises a textile support.

6. The passive fire protection device as claimed in claim 5, wherein the strip does not comprise any adhesion primer between the layer of silicone foam and the textile support.

7. A process for preparing a passive fire protection device as claimed in claim 1, the process comprising (A) the preparing a strip comprising a silicone foam, the preparation comprising the steps of:
preparing a silicone composition that forms a foam by releasing a gas;
placing the composition in a mold;
closing the mold; and
crosslinking and/or curing the silicone composition to obtain the strip comprising the silicone foam.

8. The process as claimed in claim 7, wherein the mold comprises a means for allowing for the evacuation of gases generated during the crosslinking and/or curing reaction of the silicone composition.

9. The process as claimed in claim 7, the process further comprising (B) assembling one or more of the strips comprising silicone foam.

10. The process as claimed in claim 7, wherein the passive fire protection device further comprises one or more layers comprising additives that are useful for passive fire protection.

11. The process as claimed in claim 7, wherein the passive fire protection device does not contain any additives that are capable of releasing basic water at high temperature.

12. A method of providing passive fire protection for equipment, the method comprising employing the passive fire protection device as defined in claim 1 for the passive fire protection of equipment that is important for the safety and security of a facility.

13. The method as claimed in claim 12, further comprising using the passive fire protection device for wrapping of cable trays.

14. The passive fire protection device as claimed in claim 4, wherein the at least one organopolysiloxane B further comprises at least three SiH units.

15. The process as claimed in claim 10, wherein the additives for passive fire protection include metal metasilicates.

16. The process as claimed in claim 12, wherein the equipment is selected from the group consisting of cables, cable trays, ventilation and smoke extraction ducts, feed-throughs, seals and enclosures.

17. The process as claimed in claim 13, wherein the cable trays are in high-risk facilities.

18. The process as claimed in claim 17, wherein the high risk facility is a nuclear power station.
